(19) United States
(12) Patent Application Publication
(10) Pub. No.: US 2009/0203813 A1
(43) Pub. Date: Aug. 13, 2009

(54) Epoxy Resin, Epoxy Resin Composition Having the Same, Paint Composition and Method of Forming a Coating Layer Using the Same

(75) Inventor: Jong-Moon Lee, Seoul (KR)

Correspondence Address: HARNESS, DICKEY & PIERCE, P.L.C., P.O. BOX 8910, RESTON, VA, 20195, US

(73) Assignee: DPI HOLDINGS CO., LTD., Gyeonggi-do (KR)

(21) Appl. No.: 12/227,975

(22) PCT Filed: Dec. 27, 2007
(86) PCT No.: PCT/KR2007/006871

§ 371 Date: Dec. 4, 2008

(30) Foreign Application Priority Data
Dec. 27, 2006 (KR) 10-2006-0135240

(51) Int. Cl. C09D 163/00; C08L 63/00

(52) U.S. Cl. 523/400; 525/450; 525/534

(57) ABSTRACT

In an epoxy resin having a low viscosity and excellent water resistance, an epoxy resin composition having the same, a paint composition and a method of forming a coating layer using the same, the epoxy resin composition includes an epoxy resin prepared by a reaction of a cashew nut shell liquid (CNSL) selected from cardol, cardanol, anacardic and an alkyl cardol, and a haloalkylene oxide. The paint composition having such epoxy resin composition may have excellent working efficiency and low-temperature curability, and may form a coating layer having improved water resistance.

### TECHNICAL FIELD

The present invention relates to an epoxy resin, an epoxy resin composition having the same, a paint composition and a method of forming a coating layer using the same. More particularly, the present invention relates to an epoxy resin having a low viscosity and excellent water resistance, an epoxy resin composition having the same, a paint composition and a method of forming a coating layer using the same.

### BACKGROUND ART

An epoxy resin generally has advantageous characteristics, such as good tensile and mechanical strength, high adhesiveness and excellent resistance to abrasions, impacts, acids and chemicals. Epoxy resins having such characteristics are widely used in various industrial fields, such as shipbuilding, engineering works, construction, and electric and electronic materials. Additionally, the epoxy resins are increasingly in demand as corrosion-inhibiting material used for suppressing corrosion of an easily corroded material, such as an iron plate.

For example, an epoxy resin employed in shipbuilding and heavy-duty coatings is required to have excellent dryness and wafer resistance. An epoxy resin composition including a solid-state epoxy resin having a molecular weight of at least about 1,000 and an epoxy equivalent of about 500 g/eq, and a solvent capable of adjusting the viscosity of the composition, has been used for the above purposes.

In order to reduce the viscosity of an epoxy resin composition, an epoxy reactive diluent having a glycidyl ether type has been mixed with an epoxy compound, or a non-volatile and non-reactive diluent, such as mortar, anhydrous tar, pine oil, Hi-Sol and/or Panasol has been used along with an epoxy compound. However, the epoxy resin composition including such diluents exhibits a substantially retarded curing rate and poor water resistance, since a cross-linking density between the epoxy resin composition and a curing agent is very low. Accordingly, there is still required an epoxy resin having a low viscosity as well as excellent curability and water resistance, and an epoxy resin composition having the epoxy resin.

### DISCLOSURE OF THE INVENTION

### Technical Problem

The present invention provides an epoxy resin having excellent curability and water resistance, and low viscosity.

The present invention also provides an epoxy resin composition having the above-mentioned epoxy resin.

The present invention still also provides a paint composition having the above-mentioned epoxy resin composition.

The present invention further provides a method of forming a coating layer using the above-mentioned paint composition.

### Technical Solution

According to one aspect of the present invention, an epoxy resin includes a reaction product of a cashew nut shell liquid (CNSL) and a haloalkylene oxide. The CNSL includes at least one selected from cardol, cardanol, anacardic acid and an alkyl cardol, and the epoxy resin has a viscosity of about 500 to about 3,000 cps at a temperature of about 25° C.

According to another aspect of the present invention, an epoxy resin composition includes an epoxy resin prepared by a reaction of a CNSL including at least one selected from cardol, cardanol, anacardic acid and an alkyl cardol with a haloalkylene oxide, and an epoxy compound including at least one selected from the group consisting of a bisphenol diglycidyl ether oligomer and a triglycidyl ether compound.

In an example embodiment of the present invention, the epoxy resin composition may include about 10 to about 80% by weight of the epoxy resin and about 20 to about 90% by weight of the epoxy compound. Additionally, the epoxy resin composition may have a viscosity of about 500 to about 3,000 cps at a temperature of about 25° C., and an epoxy equivalent of about 195 to about 300 g/eq.

According to still another aspect of the present invention, a paint composition includes about 50 to about 80% by weight of an epoxy resin composition including an epoxy resin prepared by a reaction of a CNSL including at least one selected from cardol, cardanol, anacardic acid and an alkyl cardol with a haloalkylene oxide, and about 20 to about 50% by weight of a curing agent.

In an example embodiment of the present invention, the paint composition may include the epoxy resin composition having an epoxy compound such as a bisphenol diglycidyl ether oligomer, a triglycidyl ether compound or a combination thereof, as well as the epoxy resin prepared by a reaction of the CNSL with the haloalkylene oxide. Additionally, the paint composition may further include an additive such as a curing accelerator, an inorganic filler, a viscosity-controlling agent or the like.

According to still another aspect of the present invention, there is provided a method of forming a coating layer on an object. In the method, a coating layer is formed by coating the object with a paint composition including about 50 to about 80% by weight of an epoxy resin composition and about 20 to about 50% by weight of a curing agent. The epoxy resin composition includes an epoxy resin prepared by a reaction of a CNSL including at least one selected from cardol, cardanol, anacardic acid and an alkyl cardol with a haloalkylene oxide.

According to the present invention, the epoxy resin composition may have a low viscosity as compared with a conventional high-viscosity epoxy resin. Thus, the epoxy resin composition may be used for forming a coating layer having excellent characteristics without using a solvent as a viscosity-dropping agent. The epoxy resin composition may also have high working efficiency owing to the low viscosity. Furthermore, the epoxy resin composition may have excellent water resistance and low-temperature curability besides the low viscosity. Therefore, the epoxy resin composition may be usefully employed as a coating agent in various industrial fields.

### BEST MODE FOR CARRYING OUT THE INVENTION

it should be understood that the example embodiments of the present invention described below may be varied modified in many different ways without departing from the inventive principles disclosed herein, and the scope of the present invention is therefore not limited to these particular following embodiments. Rather, these embodiments are provided so that this disclosure will be thorough and complete, and will fully convey the concept of the invention to those skilled in the art by way of example and not of limitation.

Epoxy Resin

An epoxy resin in accordance with example embodiments of the present invention includes a reaction product of a cashew nut shell liquid (CNSL) and a haloalkylene oxide. Examples of the CNSL include cardol, cardanol, anacardic acid, an alkyl cardol or a combination thereof.

Examples of the CNSL may be represented by the following formulas. Particularly, cardol, cardanol, anacardic acid and an alkyl cardol have chemical structures represented by Formulas 1 through 4, respectively.

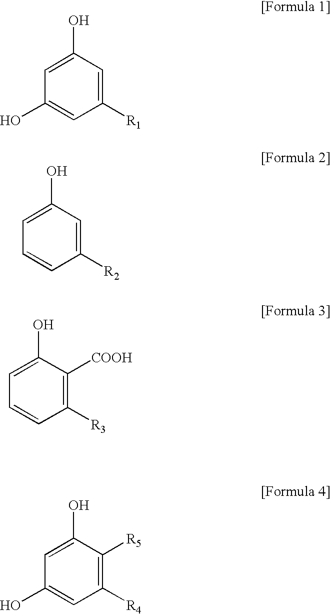

In Formulas 1 to 4, R₁, R₂, R₃ and R₄ independently denote an alkyl group having a formula C₁₅H₃₁₋ₙ, n denotes an integer selected from 0, 2, 4 and 6, and R₅ denotes a C₁-C₄ lower alkyl group.

Examples of the haloalkylene oxide that may be used for preparing the epoxy resin of the present invention, may include epichlorohydrin, epibromohydrin, epiiodohydrin, 1-chloro-3,4-epoxybutane, 1-bromo-3,4-epoxybutane, 1-iodo-3,4-epoxybutane, 1-chloro-4,5-epoxypentane, 1-bromo-4,5-epoxypentane, 1-iodo-4,5-epoxypentane, 1-chloro-5,6-epoxyhexane, 1-bromo-5,6-epoxyhexane, 1-iodo-5,6-epoxyhexane or the like. These may be used alone or in a mixture thereof.

In an example embodiment of the present invention, the epoxy resin may be prepared by reacting the CNSL with the haloalkylene oxide in a molar ratio of about 1:1 to about 1:15. When the molar ratio between the CNSL and the haloalkylene oxide is less than about 1:1, the viscosity of the epoxy resin may increase and thus the working efficiency of the epoxy resin may become poor. Further, when the molar ratio between the CNSL and the haloalkylene oxide is greater than about 1:15, the viscosity of the epoxy resin may be sufficiently low, but a yield of the reaction between the CNSL and the haloalkylene oxide may deteriorate to thereby reduce economical efficiency.

In an example embodiment of the present invention, the reaction of the CNSL with the haloalkylene oxide may be carried out at a temperature lower than about 130° C. When the reaction temperature is higher than about 130° C., an undesirable side reaction may occur so that the purity of the obtained epoxy resin may disadvantageously decrease and the viscosity of the epoxy resin may excessively increase. Furthermore, loss of the haloalkylene oxide that may be refluxed during the reaction may greatly increase, and a reaction yield may be reduced. Accordingly, the reaction of the CNSL with the haloalkylene oxide may be performed at a temperature lower than about 130° C., for example, from about 100° C. to about 110° C.

In an example embodiment of the present invention, the reaction of the CNSL with the haloalkylene oxide may be carried out using a catalyst. Examples of the catalyst may include an ammonium salt, a borate salt, a phosphonium compound, an imidazole compound, a tertiary amine compound, an alkali metal hydroxide or the like. These may be used alone or in a combination thereof.

For example, when the alkali metal hydroxide is used as the catalyst, an aqueous solution having the alkali metal hydroxide and water may be applied to the reaction. The aqueous solution of the alkali metal hydroxide may be continuously added to a mixture of the CNSL and the haloalkylene oxide, and the reaction may be carried out by refluxing the mixture. While the mixture is refluxed, water may be removed and the haloalkylene oxide may be collected and reused to the reaction. When the aqueous solution of the alkali metal hydroxide is used as the catalyst, a polar solvent such as an alcohol, an ester or the like may be added to the reaction mixture so as to generate a homogenous reaction.

In an example embodiment of the present invention, an epoxy resin may have a viscosity in a range of about 500 to about 3,000 cps at a temperature of about 25° C. When the viscosity of the epoxy resin at about 25° C. is less than about 500 cps, a low-temperature curability of the epoxy resin may deteriorate to retard drying of a coating layer, and characteristics of the coating layer, such as water resistance, strength or the like, may become worse. Additionally, when the viscosity of the epoxy resin is greater than about 3,000 cps, the working efficiency may be reduced and the uniformity of the coating layer may become poor. Therefore, the epoxy resin may have a viscosity in a range of about 500 to about 3,000 cps at a temperature of about 25° C., and preferably in a range of about 500 to about 2,500 cps.

According to example embodiments of the present invention, the epoxy resin has a low viscosity as compared with a conventional high-viscosity epoxy resin. Thus, the epoxy resin may be used for forming a coating layer having excellent characteristics without using a solvent as a viscosity-dropping agent. The epoxy resin may also have high working efficiency owing to the low viscosity. Furthermore, the epoxy resin composition has excellent water resistance and low-temperature curability besides the low viscosity. Therefore, the epoxy resin composition may be usefully employed as a coating agent in various industrial fields.

Epoxy Resin Composition

In accordance with example embodiments of the present invention, an epoxy resin composition includes an epoxy resin having a reaction product of a CNSL and a haloalkylene oxide, and an epoxy compound such as a bisphenol diglycidyl ether oligomer, a triglycidyl ether compound or a combination thereof. The epoxy resin prepared by a reaction of the CNSL and the haloalkylene oxide is previously described, so any further explanations in this regard will be omitted herein for brevity.

In an example embodiment of the present invention, when the epoxy resin composition includes less than about 10% by weight of the epoxy resin, the viscosity of the epoxy resin composition may increase to deteriorate the uniformity of a coating layer. When the amount of the epoxy resin is greater than about 80% by weight, curing reactivity may decrease. Thus, the epoxy resin composition according to an example embodiment of the present invention may include the epoxy resin in a range of about 10 to about 80% by weight.

In example embodiments of the present inventions, the epoxy resin composition includes an epoxy compound such as a bisphenol diglycidyl ether oligomer, a triglycidyl ether compound or a combination thereof.

Examples of the bisphenol diglycidyl ether oligomer that may be used in the epoxy resin composition may include a bisphenol-A diglycidyl ether oligomer having a weight-average molecular weight of about 300 to about 1,000, a bisphenol-F diglycidyl ether oligomer having a weight-average molecular weight of about 300 to about 1,000, a bisphenol-AF diglycidyl ether oligomer having a weight-average molecular weight of about 300 to about 1,000, or the like. These may be used alone or in a combination thereof.

Examples of the triglycidyl ether compound that may be used in the epoxy resin composition may include trimethylolpropane triglycidyl ether, triphenylolmethane triglycidyl ether, trimethylolethane triglycidyl ether or the like. These may be used alone or in a combination thereof.

In an example embodiment of the present invention, when the epoxy resin composition includes less than about 20% by weight of the epoxy compound, curing reactivity may decrease. When the amount of the epoxy compound is greater than about 90% by weight, the viscosity of the epoxy resin composition may increase to deteriorate the uniformity of a coating layer and working efficiency. Thus, the epoxy resin composition according to an example embodiment of the present invention may include the epoxy compound in a range of about 20 to about 90% by weight.

In an example embodiment of the present invention, when the viscosity of the epoxy resin composition at about 25° C. is less than about 500 cps, a low-temperature curability of the epoxy resin composition may deteriorate to retard drying of a coating layer, and characteristics of the coating layer, such as water resistance, strength or the like, may become worse. Additionally, when the viscosity of the epoxy resin composition is greater than about 3,000 cps, working efficiency may be reduced and the uniformity of the coating layer may become poor. Therefore, the epoxy resin composition according to an example embodiment of the present invention may have a viscosity in a range of about 500 to about 3,000 cps at a temperature of about 25° C., and preferably in a range of about 500 to about 2,500 cps.

In an example embodiment of the present invention, when the epoxy resin composition has an epoxy equivalent less than about 195 g/eq, the curing reactivity of the epoxy resin composition may decrease. When the epoxy resin composition has an epoxy equivalent greater than about 300 g/eq, the viscosity of the epoxy resin composition may excessively increase to deteriorate the working efficiency of coating. Thus, the epoxy resin composition according to an example embodiment of the present invention may have an epoxy equivalent in a range of about 195 to about 300 g/eq.

In some example embodiments of the present invention, the epoxy resin composition may include the epoxy resin having a reaction product of a CNSL and a haloalkylene oxide, a bisphenol diglycidyl ether oligomer and a triglycidyl ether compound. The epoxy resin composition may include about 10 to about 80% by weight of the epoxy resin, about 15 to about 50% by weight of the bisphenol diglycidyl ether oligomer and about 5 to about 40% by weight of the triglycidyl ether compound.

According to the present invention, the epoxy resin composition may have a low viscosity as compared with a conventional high-viscosity epoxy resin, and thus may be used for forming a coating layer having excellent characteristics without using a solvent as a viscosity-dropping agent. The epoxy resin composition may also have high working efficiency owing to the low viscosity. Furthermore, the epoxy resin composition may have excellent water resistance and low-temperature curability besides the low viscosity. Therefore, the epoxy resin composition may be usefully employed as a coating agent in various industrial fields.

Paint Composition

According to example embodiments of the present invention, a paint composition includes an epoxy resin composition having an epoxy resin prepared by a reaction of a CNSL with a haloalkylene oxide, and a curing agent.

In some example embodiments of the present invention, the epoxy resin composition included in the paint composition may include only an epoxy resin having a reaction product of the CNSL and the haloalkylene oxide. In other example embodiments of the present invention, the epoxy resin composition may include an epoxy resin having a reaction product of the CNSL and the haloalkylene oxide, and an epoxy compound such as a bisphenol diglycidyl ether oligomer, a triglycidyl ether compound or a combination thereof. In an example embodiment of the present invention, when the paint composition includes less than about 50% by weight of the epoxy resin composition, a curing rate of the paint composition is so fast that a curing reaction may not be properly controlled while a coating layer is formed using the paint composition. Physical and/or chemical characteristics of the coating layer may also deteriorate. When the amount of the epoxy resin composition is greater than about 80% by weight, the curing rate of the paint composition may decrease to retard drying of the coating layer. Therefore, the paint composition according to an example embodiment of the present invention may include the epoxy resin composition in a range of about 50 to about 80% by weight.

Examples of the curing agent that may be used in the paint composition of the present invention may include an amine, an acid anhydride, an amide or the like. Particularly, examples of the curing agent may include phenalkamine, dicyandiamide, phthalic anhydride, methyl nadic anhydride, imidazole, a BF₃-amine complex, a quinidine derivative or the like. These may be used alone or in a combination thereof.

In an example embodiment of the present invention, when the paint composition includes less than about 20% by weight of the curing agent, the curing rate may decrease to retard drying of the coating layer formed using the paint composition. When the amount of the curing agent is greater than about 50% by weight, a curing rate is so fast that a curing reaction may not be properly controlled and physical and/or chemical characteristics of the coating layer may also deteriorate. Therefore, the paint composition according to an example embodiment of the present invention may include the curing agent in a range of about 20 to about 50% by weight.

In an example embodiment of the present invention, the paint composition may include an additive such as a curing accelerator, an inorganic filler, a viscosity-controlling agent or the like considering the use and properties of the paint composition. Examples of the curing agent may include imidazole, a tertiary amine, a phosphine compound or the like. Additionally, the paint composition may include the curing agent, for example, in a range of about 0.1 to about 5 parts by weight based on about 100 parts by weight of the epoxy resin composition.

In an example embodiment of the present invention, when the viscosity of the paint composition at about 25° C. is less than about 500 cps, a low-temperature curability of the paint composition may deteriorate to retard drying of a coating layer, and characteristics of the coating layer, such as water resistance or strength may become worse. Additionally, when the viscosity of the paint composition is greater than about 3,000 cps, working efficiency may be reduced and the uniformity of the coating layer may become poor. Therefore, the paint composition according to an example embodiment of the present invention may have a viscosity in a range of about 500 to about 3,000 cps at a temperature of about 25° C., and preferably in a range of about 500 to about 2,500 cps.

According to the present invention, the paint composition may have a low viscosity as compared with a conventional high-viscosity epoxy resin, and thus may be used for forming a coating layer having excellent characteristics without using a solvent as a viscosity-dropping agent. The paint composition may also have high working efficiency owing to the low viscosity. Furthermore, the paint composition may have excellent water resistance and low-temperature curability to be usefully employed as a coating agent in various industrial fields.

Method of Forming a Coating Layer

In example embodiments of the present invention, a coating layer is formed on an object using the above-mentioned paint composition.

Particularly, the coating layer is formed on the object by coating the object with the paint composition including the epoxy resin composition having a reaction product of a CNSL and a haloalkylene oxide, and a curing agent. The paint composition is previously described, so any further explanations in this regard will be omitted herein for brevity.

The object, on which the coating layer is formed, is not limited to a type or a material. All things that require having water resistance may be the object. Examples of the object that may require corrosion inhibition may include all sorts of iron plates, shipping structures, construction materials, electric materials, electronic materials or the like.

After forming the coating layer on the object, the coating layer is kept at room temperature to cure the coating layer. As a result, the coating layer having desired characteristics may be obtained.

Hereinafter, the embodiments of the present invention are described more fully with reference to Examples and Comparative Examples. However, it is understood that the present invention should not be limited to these examples but various changes and modifications can be made by one ordinary skilled in the art within the spirit and scope of the present invention.

Preparation of an Epoxy Resin

### Synthetic Example 1

A thermometer and a condenser were installed in a 2 L four-necked flask, and then the flask was placed on a stirrer and a heater. About 600 parts by weight of cardanol, about 740 parts by weight of epichlorohydrin and about 500 ppm of triethylammonium chloride used as a catalyst were added into the flask, and then the mixture was maintained at a temperature of about 80° C. under an atmosphere including nitrogen gas. About 90 parts by weight of an aqueous sodium hydroxide solution having a temperature of about 80° C. were dropped into the mixture for about 120 minutes. The aqueous sodium hydroxide solution contained 50% by weight of sodium hydroxide. Thereafter, the reaction was carried out for additional three hours. After the reaction finished, remaining and unreacted epichlorohydrin was heated and removed from the flask using a rotary evaporator under a lowered pressure. The reaction product was dissolved in about 200 parts by weight of toluene, and then was repeatedly washed using water until a pH of the reaction product was neutral. After separating and removing an aqueous phase from the mixture, about 680 parts by weight of an epoxy resin was obtained. The epoxy resin thus obtained had a liquid phase at room temperature, an epoxy equivalent of about 420 g/eq, and a viscosity of about 30 cps at a temperature of about 25° C. which was measured by a Brookfield LVII viscometer.

### Example 1

A thermometer and a condenser were installed in a 4 L four-necked flask, and then the flask was placed on a stirrer and a heater. About 1,200 parts by weight of cardol, about 2,000 parts by weight of epichlorohydrin and about 500 ppm of triethylammonium chloride used as a catalyst were added into the flask, and then the mixture was maintained at a temperature of about 80° C. under an atmosphere including nitrogen gas. About 300 parts by weight of an aqueous sodium hydroxide solution having a temperature of about 80° C. were dropped into the mixture for about 120 minutes. The aqueous sodium hydroxide solution contained 50% by weight of sodium hydroxide. Thereafter, the reaction was carried out for additional three hours. After the reaction finished, remaining and unreacted epichlorohydrin was heated and removed from the flask using a rotary evaporator under a lowered pressure. The reaction product was dissolved in about 500 parts by weight of toluene, and then was repeatedly washed using water until a pH of the reaction product was neutral. After separating and removing an aqueous phase from the mixture, about 1,650 parts by weight of an epoxy resin was obtained. The epoxy resin thus obtained had a liquid phase at room temperature, an epoxy equivalent of about 250 g/eq, and a viscosity of about 1,050 cps at a temperature of about 25° C. which was measured by a Brookfield LVII viscometer.

Preparation of an Epoxy Resin Composition

### Example 2

About 15 parts by weight of the epoxy resin prepared in Synthetic Example 1, about 10 parts by weight of trimethylolpropane triglycidyl ether, and about 75 parts by weight of a bisphenol-A epoxy resin having a weight-average molecular weight of about 380 were mixed at room temperature for about 30 minutes to thereby prepare an epoxy resin composition. The epoxy resin composition thus obtained had a liquid phase at room temperature, an epoxy equivalent of about 200 g/eq, and a viscosity of about 1,500 cps at a temperature of about 25° C. which was measured by a Brookfield LVII viscometer.

### Example 3

About 10 parts by weight of the epoxy resin prepared in Synthetic Example 1, about 60 parts by weight of the epoxy resin prepared in Example 1, and about 30 parts by weight of a bisphenol-A epoxy resin having a weight-average molecular weight of about 380 were mixed at room temperature for about 30 minutes to thereby prepare an epoxy resin composition. The epoxy resin composition thus obtained had a liquid phase at room temperature, an epoxy equivalent of about 240 g/eq, and a viscosity of about 950 cps at a temperature of about 25° C. which was measured by a Brookfield LVII viscometer.

### Comparative Example 1

A commercial epoxy resin YD-128 (trade name, manufactured by Kukdo Chemical Co., Ltd., Korea), which had an epoxy equivalent of about 190 g/cq, and a viscosity of about 12,000 cps, was prepared.

Preparation of a Paint Composition

### Example 4

A paint composition was obtained by mixing about 100 parts by weight of the epoxy resin prepared in Example 1 and about 50 parts by weight of Cardolite-NC-541 LV (trade name, manufactured by Cardolite Corp., U.S.A.), which was a phenalkamine curing agent having a viscosity of about 1,500 to about 3,000 cps, an active hydrogen equivalent weight (AHEW) of about 125, and an amine value of about 310 to about 345 mgKOH/g.

### Examples 5 and 6

A paint composition was obtained by performing processes substantially the same as those of Example 4 except that the epoxy resin of Example 1 was replaced with each of the epoxy resin compositions prepared in Examples 2 and 3, and a mixing ratio of the epoxy resin composition (or the epoxy resin) and the curing agent was changed. The mixing ratio means a weight ratio of the epoxy resin composition (A) relative to the curing agent (B). The mixing ratios of the paint compositions are shown in Table 1.

### Comparative Examples 2 and 3

A paint composition was obtained by performing processes substantially the same as those of Example 4 except that the epoxy resin of Example 1 was replaced with each of the epoxy resin prepared in Synthetic Examples 1 and Comparative Example 1, and a mixing ratio of the epoxy resin and the curing agent was changed.

TABLE 1

| | Mixing Ratio |
|---|---|
| | (A/B) |
| Example 4 | 100/50 |
| Example 5 | 100/63 |
| Example 6 | 100/50 |
| Comparative Example 2 | 100/30 |
| Comparative Example 3 | 100/66 |

Evaluation of Viscosity

Viscosities of the epoxy resins, the epoxy resin compositions and the paint compositions were measured using a Brookfield LVII viscometer at a temperature of about 25° C. The results are shown in Table 2.

TABLE 2

| | | Viscosity [cps] |
|---|---|---|
| Epoxy Resin | Synthetic Example 1 | 30 |
| | Example 1 | 1,050 |
| Epoxy Resin Composition | Example 2 | 1,500 |
| | Example 3 | 950 |
| | Comparative Example 1 | 12,000 |
| Paint Composition | Example 4 | 1,550 |
| | Example 5 | 1,750 |
| | Example 6 | 1,400 |
| | Comparative Example 2 | 120 |
| | Comparative Example 3 | 6,200 |

As shown in Table 2, the epoxy resin compositions and the paint compositions of the present invention had viscosities lower than or equal to about 3,000 cps at a temperature of about 25° C. These viscosities are substantially lower than that of the conventional epoxy resin composition. Accordingly, the epoxy resin composition and the paint composition of the present invention may form a coating layer without using an additional solvent or a diluent. Further, the epoxy resin composition and the paint composition of the present invention may be employed in forming a coating layer having improved coatability.

Evaluation of Low-Temperature Curability

Low-temperature curabilities at a temperature of about 5° C. were evaluated for the paint compositions prepared in Examples 4 to 6 and Comparative Examples 2 and 3. A coating layer was formed on an iron plate using each of the paint compositions to have a thickness of about 300 μm, and then a time required for a finger-touch dryness was measured using a BK Drying Time Recorder (model name: BK3, manufactured by Sheen Instruments Ltd., U.K.). The results are shown in Table 3.

TABLE 3

| | Time for Finger-Touch Dryness [hr] |
|---|---|
| Example 4 | 8 |
| Example 5 | 14 |
| Example 6 | 11 |
| Comparative Example 2 | 98 |
| Comparative Example 3 | 50 |

As shown in Table 3, the paint compositions of the present invention exhibited a finger-touch dryness within about 15 hours. Therefore, it may be confirmed that the paint compositions of the present invention has excellent natural dryness and low-temperature curability.

Evaluation of Water Resistance

Water resistance levels of cured coating layers were evaluated for the paint compositions prepared in Examples 4 to 6 and Comparative Examples 2 and 3.

A coating layer was formed on a 7×15 cm² iron plate using each of the paint compositions to have a thickness of about 300 μm, and then the coating layer was dried at room temperature for about 7 days to thereby form a sample for an accelerating test. The sample was positioned as a partition between a cold bath and a hot bath of an osmotic system. In this system, water may rapidly permeate into the coating layer due to an osmotic pressure generated by a temperature difference between cold and hot baths, and thus a blister on the coating layer or corrosion of the iron plate may occur. The hot bath was maintained at a temperature of about 50° C., and the cold bath was maintained at about 30° C.

After each sample was placed between the cold and the hot baths for about 100 hours, water resistance of the coating layer was evaluated by counting the number of a blister generated in the coating layer. The results are shown in Table 4.

TABLE 4

| | Number of Blister |
|---|---|
| Example 4 | 8 |
| Example 5 | 5 |
| Example 6 | 3 |
| Comparative Example 2 | >100 |
| Comparative Example 3 | >100 |

As shown in Table 4, the coating layers formed using the paint compositions prepared in Comparative Examples 2 and 3 exhibited more than about 100 blisters. However, the coating layers formed using the paint compositions of the present invention showed a small number of blisters less than or equal to about 8 blisters. Therefore, it may be noted that the paint compositions of the present invention has excellent water resistance as well as a viscosity lower than about 3,000 cps.

### INDUSTRIAL APPLICABILITY

According to example embodiments of the present invention, the epoxy resin composition may have enhanced low-temperature curability and water resistance. The epoxy resin composition may also have a low viscosity as compared with a conventional epoxy resin having a high viscosity. Thus, the epoxy resin composition may be used for forming a coating layer having excellent characteristics without using a solvent as a viscosity-dropping agent. The epoxy resin composition may also have high working efficiency owing to the low viscosity. Therefore, the epoxy resin composition may be usefully employed as a coating agent in various industrial fields such as modifiers, textiles, paper, automobiles, sports equipment, timber, construction, marine engineering, shipbuilding or the like.

1. An epoxy resin composition comprising:
an epoxy resin prepared by a reaction of a cashew nut shell liquid (CNSL) and a haloalkylene oxide, the CNSL including at least one selected from cardol, cardanol, anacardic acid and an alkyl cardol; and
an epoxy compound including at least one selected from the group consisting of a bisphenol diglycidyl ether oligomer and a triglycidyl ether compound.

2. The epoxy resin composition of claim 1, wherein the epoxy resin composition comprises about 10 to about 80% by weight of the epoxy resin and about 20 to about 90% by weight of the epoxy compound.

3. The epoxy resin composition of claim 1, wherein the epoxy resin composition comprises about 10 to about 80% by weight of the epoxy resin, about 15 to about 50% by weight of the bisphenol diglycidyl ether oligomer and about 5 to about 40% by weight of the triglycidyl ether compound.

4. The epoxy resin composition of claim 1, wherein the epoxy resin is prepared by reacting the CNSL with the haloalkylene oxide in a molar ratio of about 1:1 to about 1:15.

5. The epoxy resin composition of claim 1, wherein the bisphenol diglycidyl ether oligomer comprises at least one selected from the group consisting of a bisphenol-A diglycidyl ether oligomer having a weight-average molecular weight of about 300 to about 1,000, a bisphenol-F diglycidyl ether oligomer having a weight-average molecular weight of about 300 to about 1,000, and a bisphenol-AF diglycidyl ether oligomer having a weight-average molecular weight of about 300 to about 1,000.

6. The epoxy resin composition of claim 1, wherein the triglycidyl ether compound comprises at least one selected from the group consisting of trimethylolpropane triglycidyl ether, triphenylolmethane triglycidyl ether and trimethylolethane triglycidyl ether.

7. The epoxy resin composition of claim 1, wherein the epoxy resin composition has a viscosity of about 500 to about 3,000 cps at a temperature of about 25° C.

8. The epoxy resin composition of claim 1, wherein the epoxy resin composition has an epoxy equivalent of about 195 to about 300 g/eq.

9. An epoxy resin comprising:
a reaction product of a CNSL and a haloalkylene oxide, the CNSL including at least one selected from cardol, cardanol, anacardic acid and an alkyl cardol, the epoxy resin having a viscosity of about 500 to about 3,000 cps at a temperature of about 25° C.

10. A paint composition comprising:
about 50 to about 80% by weight of an epoxy resin composition including an epoxy resin prepared by a reaction of a CNSL and a haloalkylene oxide, the CNSL including at least one selected from cardol, cardanol, anacardic acid and an alkyl cardol; and
about 20 to about 50% by weight of a curing agent.

11. The paint composition of claim 10, wherein the epoxy resin composition further comprises at least one epoxy compound selected from the group consisting of a bisphenol diglycidyl ether oligomer and a triglycidyl ether compound.

12. The paint composition of claim 10, wherein the paint composition has a viscosity of about 500 to about 3,000 cps at a temperature of about 25° C.

13. The paint composition of claim 10, wherein the paint composition further comprises at least one additive selected from the group consisting of a curing accelerator, an inorganic filler and a viscosity-controlling agent.

14. A method of forming a coating layer on an object comprising:
forming a coating layer by coating the object with a paint composition including about 50 to about 80% by weight of an epoxy resin composition and about 20 to about 50% by weight of a curing agent, the epoxy resin composition including an epoxy resin prepared by a reaction of a CNSL and a haloalkylene oxide, the CNSL including at least one selected from cardol, cardanol, anacardic acid and an alkyl cardol.
